(19) United States
(12) Patent Application Publication
(10) Pub. No.: US 2021/0350719 A1
(43) Pub. Date: Nov. 11, 2021

(54) SKILL ASSESSMENT TEST CALIBRATION

(71) Applicant: Microsoft Technology Licensing, LLC, Redmond, WA (US)

(72) Inventors: Christian Valdemar Mathiesen, San Jose, CA (US); Jiaqi Meng, San Jose, CA (US); Alp Artar, San Francisco, CA (US); Joel Daniel Young, Milpitas, CA (US)

(21) Appl. No.: 16/868,362

(22) Filed: May 6, 2020

(51) Int. Cl. G09B 7/08; G06Q 10/10; G06Q 50/20; G06Q 30/02; G06Q 10/06; G06N 7/00; G06N 20/00

(52) U.S. Cl. CPC G09B 7/08; G06Q 10/105; G06Q 50/2057; G06N 20/00; G06Q 10/06311; G06N 7/005; G06Q 30/0204

(57) ABSTRACT

Disclosed are systems, methods, and non-transitory computer-readable media for skill assessment test calibration. An assessment test calibration system presents a test question relating to a skill to a set of users of an employment services platform. The assessment test calibration system receives a set of answers provided by the users for the test question and determines a difficultly score for the test questions based on the set of answers and the profile data included in the user profiles of the set of users. The difficulty score indicates an estimated level of difficulty of the test question. The test question is presented as part of an adaptive skill assessment test administered to determine a user's proficiency in the skill. The test question is presented at a point during the adaptive skill assessment test based the difficulty score determined for the test question.

### TECHNICAL FIELD

An embodiment of the present subject matter relates generally to skill assessment and, more specifically, to skill assessment test calibration.

### BACKGROUND

Some online services provide professional career related services. For example, an online service may provide an employment-related platform for job listings. This type of service allows job seekers to search available job listings and apply to positions of interest. Similarly, recruiters may use the service to view user profiles to identify users that have the requisite skills for an open position. For example, a user's profile may list the user's career history, education history, skill set, etc. Recruiters often want to verify the skills of a candidate.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system for skill assessment test calibration, according to some example embodiments.

FIG. 2 is a block diagram of an assessment test calibration system, according to some example embodiments.

FIGS. 3A and 3B are block diagrams illustrating the functionality of the assessment test calibration system, according to some example embodiments.

FIG. 4 is a flowchart showing an example method of skill assessment test calibration, according to certain example embodiments.

FIG. 5 is a flowchart showing an example method of recalibrating a skill assessment test, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for skill assessment test calibration. Some online services administer skill assessment tests to verify that a job seeker is adequately proficient at a skill. For example, a user may select to take a skill assessment test to provide potential employers with verification that the user is proficient in the skill. The user's profile may be updated to indicate that the user has successfully passed the skill assessment test. To ensure that a skill assessment test accurately verifies whether a user is adequately proficient at a skill, the skill assessment test is calibrated to include questions of varying difficulty levels. Currently, the process of test calibration is performed manually by human reviewers. The reviewers evaluate questions and determine the level of difficulty of the questions, which are then used to formulate the skill assessment test. This process is flawed as use of human reviewers is slow, expensive, and may provide inaccurate results that are based on the opinions of a small number of reviewers. To alleviate these issues, an assessment test calibration system leverages an employment services platform to automate the test calibration process.

An employment services platform is an online service that allows users to provide data representing their professional identities. For example, an employment services platform may be a professional networking service, such as LINKEDIN, that facilitates professional networking among its members. For example, members may create user profiles describing their professional identities (e.g., education and work history, proficient skills, etc.), view the user profiles of other members, and/or connect with other members (e.g., message, establish a profile connection, and the like) An employment services platform may also be a platform that facilitates the hiring process between employers and job seekers, such as by allowing employers to post open job listings and enabling job seekers to search and/or apply to the listed job listings. Job seekers may create a profile including their resume or other data describing their professional identities. Recruiters may search and view the user profiles to identify qualified candidates for open positions.

The assessment test calibration system leverages the employment services platform to determine difficulty scores for test questions. The difficulty scores indicated an estimated level of difficulty of the test question. The difficulty scores determined for the test questions are used to calibrate a skill assessment test for a specified skill. For example, the difficulty scores are used to select a set of test questions for the skill assessment test to provide a desired level of difficulty. As another example, the difficulty scores may be used to administer an adaptive test in which the test questions presented to a test taker are selected based on the test takers performance during the test, such as by selecting a test question with a higher difficulty score when the test taker answers a previous question correctly or selecting a test question with a lower difficulty score when the test taker answers a previous question incorrectly.

To determine the difficulty score for a test question, the assessment test calibration system identifies users of the employment services platform that are qualified to answer the test question. For example, the assessment test calibration system may use profile data of the users to identify users that have identified themselves as possessing a skill being tested by the test question and/or that have an employment and/or education history indicating that the users possess the skill being tested by the test questions.

The assessment test calibration system presents the test question to the identified users to gather answers, which can then be used to determine the difficulty score for the test question. The test question may be presented to a subset of the users identified as being qualified to answer the test question. For example, the assessment test calibration system may present the test question to a limited number of users determined to provide adequate data to calculate the difficulty score. In some embodiments, the assessment test calibration system may determine the number or users based on a historical response rate to achieve the number of answers needed within a desired time frame.

The test question may be presented within a beta skill assessment test or within a live skill assessment test that has already been calibrated. A beta skill assessment test may be an assessment test that includes multiple test questions that have not yet been calibrated and which is administered to users with the primary goal of determining the difficulty values for the test questions rather than determining whether a user is adequately proficient at a certain skill.

In contrast, a live skill assessment test is an assessment test that has been calibrated and that is administered with the primary goal of determining whether a user is adequately proficient at a certain skill. In this type of embodiment, a new test question that has not yet been assigned a difficulty score may be included as a test question in the live skill assessment test along with other test questions that have been assigned difficulty scores. The new test question may be presented in the live skill assessment test for experimental purposes to gather data used for determining the difficulty value of the test question and therefore may have no impact on whether a user passes or fails the live skill assessment test.

In either case, the assessment test calibration system gathers answers provided by the users to a test question and uses the answers to determine a difficulty score for the test question. The assessment test calibration system may determine the difficulty score based on the answers provided by the user, as well as other data, such as the test question itself and/or profile data included in the user profiles of the users that provided the answers. For example, the assessment test calibration system may use the data as input into a model, such as a Rasch model, that generates a probability value indicating the likelihood that the test question will be answered correct. The assessment test calibration system may then use the resulting probability value to assign a difficulty score for the test question.

After difficulty scores have been determined for test questions and the test questions are used within live skill assessment tests the assessment test calibration system may continuously monitor the live skill assessment tests and recalibrate them as needed. For example, the assessment test calibration system may use answers provided by test takes during the live assessment to recalculate the difficulty scores assigned to the test questions. The assessment test calibration system may also monitor a pass rate associated with a live skill assessment test to ensure that the pass rate does not exceed a predetermined threshold rate. In the event that the pass rate for a live skill assessment test does exceed the predetermined threshold rate, the assessment test calibration system may stop administering the assessment test until it has been properly recalibrated.

Leveraging the employment services platform to determine difficulty scores for test questions provides several technical improvements over prior systems. For example, the speed at which assessment tests are calibrated is greatly increased, thereby improving the perceived speed of the computing devices. Further, the quality of the data generated by the computing devices is improved over prior systems as both a larger data set is used in calibrating the assessment tests and the data is a much more accurate representation of the difficulty of the test questions as the users providing answers are the intended audience and may be answering the test question under the assumption that it is a part of a live skill assessment test.

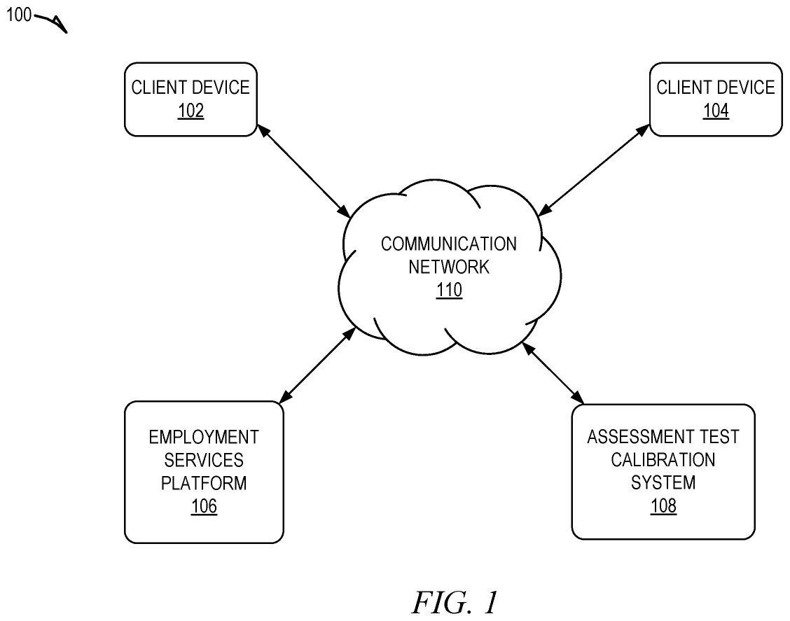

FIG. 1 shows an example system 100 for skill assessment test calibration, according to some example embodiments. As shown, multiple devices (i.e., client device 102, client device 104, employment services platform 106, and assessment test calibration system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

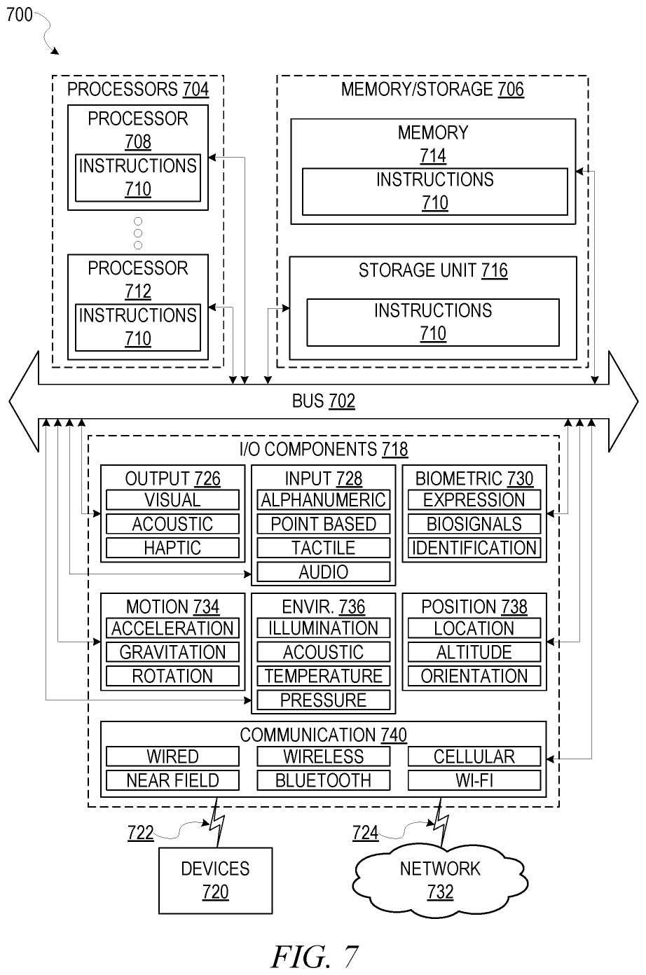

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate component running on the computing device. The communication interface also sends a communication to another computing device in network communication with the computing device.

In the system 100, users interact with the employment services platform 106 to utilize the services provided by the employment services platform 106. Users communicate with and utilize the functionality of the employment services platform 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the employment services platform 106 may concurrently accept connections from and interact with any number of client devices 102, 104. The employment services platform 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the employment services platform 106 via a client-side application installed on the client devices 102 and 104. In some embodiments, the client-side application includes a component specific to the employment services platform 106. For example, the component may be a stand-alone application, one or more application plug-ins, and/or a browser extension. However, the users may also interact with the employment services platform 106 via a third-party application, such as a web browser, that resides on the client devices 102 and 104 and is configured to communicate with the employment services platform 106. In either case, the client-side application presents a user interface (UI) for the user to interact with the employment services platform 106. For example, the user interacts with the employment services platform 106 via a client-side application integrated with the file system or via a webpage displayed using a web browser application.

The employment services platform 106 is one or more computing devices configured to provide online employment related services. For example, an employment services platform 106 may be a professional social networking service for business professionals (e.g., LINKEDIN) that facilitates professional networking among its members. As another example, an employment services platform 106 may be a platform that facilitates the hiring process between employers and job seekers, such as by allowing employers to post open job listings and enabling job seekers to search and/or apply to the listed job listings.

In any case, the employment services platform 106 allows users to provide data representing their professional identities. For example, the employment services platform 106 allows users to create user profiles including data such as their education and work history, goals, personal description, proficient skills, achievements, interests, etc. This data may be accessible to other users of the employment services platform 106. For example, other users may view the user profiles of other members and/or connect with other members (e.g., message, establish a profile connection, etc.). As another example, users, such as recruiters, may search and view the user profiles to identify qualified candidates for open positions.

As part of its provided services, the employment services platform 106 may administer skill assessment tests to provide verification that a user is adequately proficient in a certain skill. A skill assessment test is a test including a set of test questions meant to determine a user's level or proficiency at a specified skill. For example, a skill assessment test for a skill such as computer networking may include a set of test questions related to computer networking. Users that successfully score above a specified threshold on the skill assessment test (e.g., answer a specified number of the test questions correctly) are verified as having adequate proficiency in the tested skill. The employment services platform 106 may provide a visual indicator on a user profile that indicates that the user's proficiency level in the skill has been tested and/or verified.

Skill assessment tests are calibrated to ensure that users that pass the test possess at least a threshold level of proficiency in the tested skill. For example, the skill assessment test is calibrated to include test questions of adequate difficulty levels to ensure that users that pass the skill assessment test possess the threshold level of proficiency in the tested skill and that users that do not possess the threshold level of proficiency in the tested skill are unlikely to pass. Accordingly, difficulty scores indicating the difficulty level of the test questions are used to calibrate a skill assessment test. For example, the difficulty scores are used to select a set of test questions for the skill assessment test to provide a desired level of difficulty. As another example, the difficulty scores may be used to administer an adaptive test in which the test questions presented to a test taker are selected based on the test takers performance during the test, such as by selecting a test question with a higher difficulty score when the test taker answers a previous question correctly or selecting a test question with a lower difficulty score when the test taker answers a previous question incorrectly.

The employment services platform 106 uses the functionality of the assessment test calibration system 108 to calibrate assessment tests. Although the employment services platform 106 and the assessment test calibration system 108 are shown separately in FIG. 1, this is just one possible embodiment and is not meant to be limiting. The functionality of the assessment test calibration system 108 may be partially or wholly integrated within the employment services platform 106.

The assessment test calibration system 108 leverages the employment services platform 106 to determine difficulty scores for test questions. The difficulty scores indicate an estimated level of difficulty of the test question, which are used to calibrate a skill assessment test for a specified skill.

To determine the difficulty score for a test question, the assessment test calibration system 108 identifies users of the employment services platform 106 that are qualified to answer the test question. For example, the assessment test calibration system 108 may use profile data of the users to identify users that have identified themselves as possessing a skill being tested by the test question and/or that have an employment and/or education history indicating that the users possess the skill being tested by the test questions.

The assessment test calibration system 108 presents the test question to the identified users to gather answers, which can then be used to determine the difficulty score for the test question. The test question may be presented to a subset of the users identified as being qualified to answer the test question. For example, the assessment test calibration system 108 may present the test question to a limited number of users determined to provide adequate data to calculate the difficulty score. In some embodiments, the assessment test calibration system 108 may determine the number or users based on a historical response rate to achieve the number of answers needed within a desired time frame.

The test question may be presented within a beta skill assessment test or within a live skill assessment test that has already been calibrated. A beta skill assessment test may be a skill assessment test that includes multiple test questions that have not yet been calibrated and which is administered to users with the primary goal of determining the difficulty values for the test questions rather than determining whether a user is adequately proficient at a certain skill.

In contrast, a live skill assessment test is an assessment test that has been calibrated and that is administered with the primary goal of determining whether a user is adequately proficient at a certain skill. In this type of embodiment, a new test question that has not yet been assigned a difficulty score may be included as a test question in the live skill assessment test along with other test questions that have been assigned difficulty scores. The new test question may be presented in the live skill assessment test for experimental purposes to gather data used for determining the difficulty value of the test question and therefore may have no impact on whether a user passes or fails the live skill assessment test.

In either case, the assessment test calibration system 108 gathers answers provided by the users to a test question and uses the answers to determine a difficulty score for the test question. The assessment test calibration system 108 may determine the difficulty score based on the answers provided by the user, as well as other data, such as the test question itself and/or profile data included in the user profiles of the users that provided the answers. For example, the assessment test calibration system 108 may use the data as input into a model, such as a Rasch model, that generates a probability value indicating the likelihood that the test question will be answered correct. The assessment test calibration system 108 may then use the resulting probability value to assign a difficulty score for the test question.

After difficulty scores have been determined for test questions, the test questions can be used within live skill assessment tests, which the assessment test calibration system 108 may continuously monitor and recalibrate as needed. For example, the assessment test calibration system 108 may use answers provided by test taker during the live assessment to recalculate the difficulty scores assigned to the test questions. The assessment test calibration system 108 may also monitor a pass rate associated with a live skill assessment test to ensure that the pass rate does not exceed a predetermined threshold rate. In the event that the pass rate for a live skill assessment test does exceed the predetermined threshold rate, administration of the live skill assessment test may be stopped until it has been properly recalibrated by the assessment test calibration system 108.

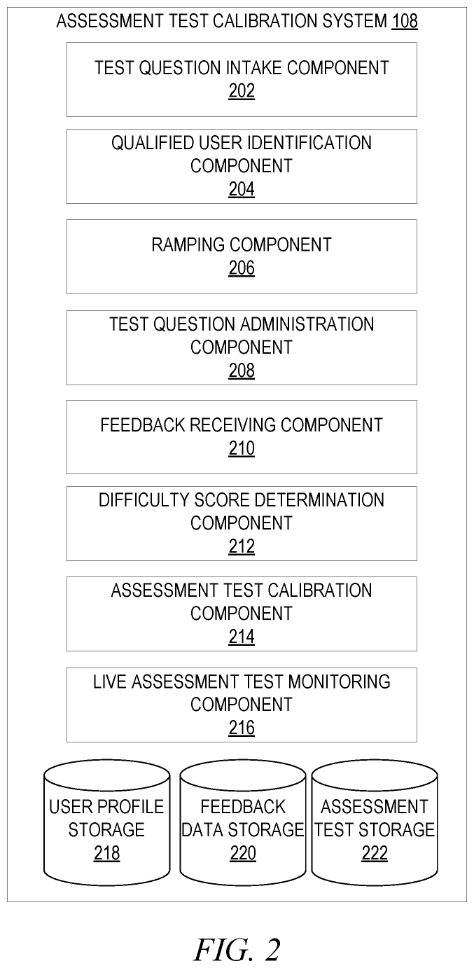

FIG. 2 is a block diagram of an assessment test calibration system 108, according to some example embodiments. To avoid obscuring the inventive subject matter with unnecessary detail, various functional components (e.g., software components) that are not germane to conveying an understanding of the inventive subject matter have been omitted from FIG. 2. However, a skilled artisan will readily recognize that various additional functional components may be supported by the assessment test calibration system 108 to facilitate additional functionality that is not specifically described herein. Furthermore, the various functional components depicted in FIG. 2 may reside on a single computing device or may be distributed across several computing devices in various arrangements such as those used in cloud-based architectures.

As shown, the assessment test calibration system 108 includes a test question intake component 202, a qualified user identification component 204, a ramping component 206, a test question administration component 208, a feedback receiving component 210, a difficulty score determination component 212, an assessment test calibration component 214, a live skill assessment test monitoring component 216, and a data storage 218.

The test question intake component 202 intakes test questions to be calibrated. The test questions may be received from content creators that create the test questions. For example, the content creators may be human users that write test questions related to one or more skills or subjects. The test question intake component 202 may receive the test questions from a client device 102 of a content creator. For example, a content creator may use their client device 102 to communicate with the assessment test calibration system 108 to submit tests questions.

Alternatively, in some embodiments, the test question intake component 202 may access the test questions created by the content creators from a content management system (not shown). In this type of embodiments, the content creators submit the test questions they create to the content management system and the test question intake component 202 receives the test questions from the content management system. For example, the content management system may transmit the test questions to the assessment test calibration system 108, which are then received by the test question intake component 202. As another example, the test questions intake component 202 may transmit a request to the content management system for the test questions, which the content management system may return in response.

Each test question may include the body of the test question, including any text, images, or other media meant to convey the question to a test takes, as well as a correct answer or set of acceptable answers to the question. A test question may also include a set of possible answers, which includes one or more correct answers and one or more incorrect answers, such as is common with true/false or multiple-choice questions. For example, a test taker that is presented with the question is also presented with the set of possible answers, from which the test taker may select one of more of the possible answers to provide an answer to the test question.

A test question may also include data identifying a topic or topics being tested by the test question. For example, a test question may include one or more tag identifiers that each identify a topic being tested by the test questions. A test question may also include data identifying skill assessment tests. For example, a test question may include a unique test identifier assigned to a skill assessment test in which the test question is to be included. This may include a live skill assessment test being administered by the assessment test calibration system 108 or a beta skill assessment test that is in the process of being calibrated.

The test question intake component 202 may store the received test questions in the assessment test storage 222. Further, the test question intake component 202 may associate the test question with any other data and/or test questions as needed. For example, the test question intake component 202 may associate a test question with a skill and/or skill assessment test based on the data received with the test question.

The qualified user identification component 204 identifies qualified users of the employment services platform 106 to which a test question can be administered for purposes of determining difficulty scores. The test question may be administered within a live skill assessment test or as part of a beta skill assessment test.

The qualified user identification component 204 may use profile data of the users of the employment services platform 106 to identify users that possess a specified skill profile that qualify the users as being able to answer the test question. The specified skill profile may be defined based on one or more factors, such as skills possessed by a user, employment history, education history, and the like. For example, the specified skill profile may be simply defined as users that have indicated that they possess a skill being tested by a test question and/or skill assessment test in which the test question is to be included. As another example, the specified skill profile may be defined as users having indicated that they have a specified skill and having a threshold amount of working experience in a related field. As another example, the specified skill profile may be defined as users having indicated that they have a specified skill and having earned specified degree and/or have a job with a specified job title.

The qualified user identification component 204 identifies the qualified users by accessing user profile data of the employment services platform 106. The user profile data includes data included in the user profiles of the users of the employment services platform 106, such as education history data (e.g., schools attended, degrees earned, etc.), employment history data (e.g., job current and/or previously held, years spent at jobs, job titled, etc.), possessed skills, and the like. The qualified user identification component 204 may access the user profile data from the user profile storage 218. Although the user profile storage 218 is shown as being a part of the assessment test calibration system 108, this is just one example and is not meant to be limiting. The user profile storage 218 may be partially or completely maintained by the employment services platform 106, just as the assessment test calibration system 108 may be completely or partially incorporated as part of the employment services platform 106.

The qualified user identification component 204 searches the profile data based on the specified skill profile for a test question to identify a subset of the qualified users of the employment services platform 106 to which the test question can be administered for purposes of determining difficulty scores. A qualified user is not necessarily a user that is able to answer the test question correctly, but rather a user that has a background and/or skill set related to the skill such that an answer provided by the user to the test question would provide meaningful data in evaluating the difficulty level of the test question. For example, users that have no background related to a tested skill would provide answers that were merely guesses, which are not meaningful in evaluating the difficulty level of a test question.

The ramping component 206 determines a number of qualified users to which a test question is to be presented to allow for a difficulty score to be determined for the test question within a target time frame. To properly determine the difficulty level of a test question, a threshold number of answers to the test questions can be collected. That is, answers should be received from a threshold number of qualified users to properly determine the difficultly score of a test question. This goal of gathering an adequate number of answers should be balanced with the goal of limiting the number of qualified users to which the test question is presented prior to the difficulty score being determined. This is because the test question is to be used to gauge whether users possess the tested skill and should therefore preferably be unknown to the test takers when administered for this purpose.

The ramping component 206 balances these goals by selecting a number of qualified users to which the test question is to be presented to provide a sufficient number of answers within a target time frame, while also limiting the number of users to which the test question is presented. The target time frame defines a desired period of time in which the difficulty score is to be determined for a test question, such as within 24 hours, 2 days, and the like.

The ramping component 206 selects the number of qualified users based on a target number of responses and a historical response rate that indicates the percentage of users that will provide a response within a specified time period when prompted to answer the question. The target number of responses is a predetermined number of responses that is desired to determine the difficulty score for a test question. For example, an administrator may select the target number of responses based on personal experience or knowledge regarding the number of answers to determine a reliable difficulty score. The ramping component 206 uses the historical response rate to determine the number of users to which the test question should be presented to cause the target number of responses (e.g., answers) to be received so that the difficulty score can be successfully determined within the target time frame. For example, given a target number of 200 and a historical response rate of 50%, the ramping component 206 will determine that the test question should be presented to 400 users (e.g., 400×50%=200).

The ramping component 206 may select the number of users to minimize the number of responses received in excess of the target number of responses. For example, the ramping component 206 may select a number of users to result in exactly the number of target response or within a desired threshold amount, either above or below, the target number of responses. For example, given the above example of a target number of 200 answers and a historical response rate of 50%, the ramping component 206 may determine the number of users based on the target number (e.g., 200), a number above the target number (e.g., 205), or a number below the target number (e.g., 195). The ramping component 206 may monitor the number of responses received and determine that the number of users should be increased or decreases. For example, the ramping component 206 may select a number of users to receive the test question during an initial phase and determine the number of users to receive the test question during a subsequent phase based on the number of responses received during the initial phase.

The test administration component 208 manages administering skill assessment tests to users of the employment services platform 106. For example, the test administration component 208 causes presentation of a test interface on a client device 102 of a user. The test interface presents test questions to users and allows users to provide answers to the presented questions, such as by entering an answer and/or selecting from a presented possible answer.

The test administration component 208 may access the skill assessment tests from the assessment test storage 222. Each adaptive skill test may be associated with a unique test identifier, which the test administration component 208 uses to identify a desired skill assessment test. The stored skill assessment tests may include a set of test questions as well as the test configuration data describing how the skill assessment test is to be administered. For example, the test configuration data may indicate an amount of time allotted to conduct the skill assessment test and/or answer individual test questions, how test questions are to be presented, how skill assessment test is to be graded, and the like.

The test administration component 208 may administer static and/or adaptive skill assessment tests. A static skill assessment test has a defined set of test questions that are each presented to a test taker in a predetermined order. In contrast, an adaptive skill assessment test is a test in which the test questions presented to the test taker are selected based on the performance of the test taker. For example, a test taker that has answered a test question or set of test questions correctly may be presented with a subsequent test question that is more difficult than the previously presented test questions. Similarly, a test taker that has answered a test question or set of test questions incorrectly may be presented with a subsequent test question that is less difficult than the previously presented test questions. To administer an adaptive skill assessment test, the test administration component 208 uses the difficulty scores assigned to the test questions to select the subsequent test question to be presented to the user.

The test administration component 208 administers both live skill assessment tests and beta skill assessment tests. A live skill assessment test is a skill assessment test that has been calibrated (e.g., includes test questions with determined difficulty scores) and that is administered with the primary goal of determining whether a user is adequately proficient at a certain skill. A beta skill assessment test that includes multiple test questions that have not yet been calibrated and which is administered to users with the primary goal of determining the difficulty values for the test questions rather than determining whether a user is adequately proficient at a certain skill.

The test administration component 208 may present users with test questions for which a difficulty score has not yet been determined as part of a live skill assessment test or a beta skill assessment test. For example, a qualified user may be prompted to take a beta skill assessment test for the purposes of calibrating the skill assessment test. In this type of embodiment, the user may be offered a reward or some other form of compensation for agreeing to participate in the beta skill assessment test. Alternatively, a test question for which a difficulty score has not yet been determined may be administered within a live skill assessment test along with other test questions that have been assigned difficulty scores. The test question may be presented in the live skill assessment test for experimental purposes to gather data used for determining the difficulty value of the test question and therefore may have no impact on whether a user passes or fails the live skill assessment test.

The feedback receiving component 210 receives feedback data resulting from presentation of test questions to qualified users. The feedback data includes answers submitted by the users to the test question. The feedback receiving component 210 may store the feedback data in the feedback data storage 220. The feedback data may include an answer provided by a user to a presented test question, such as an entered answer and/or a selection of a possible answer presented to the user. The feedback data may also include data identifying the user to which the skill assessment test is being administered, such as a unique device, account or user identifier. The feedback data may also include data identifying the particular test question to which the answer was provided as well as the skill assessment test in which the test was presented, such as unique test question and/or skill assessment identifier.

The difficulty score determination component 212 determines the difficulty score for a test question based on the feedback data stored in the feedback data storage 220 and the user profile data stored in the user profile data storage 218. For example, the difficulty score determination component 212 uses the answers provided by the users to the test question along with user profile data associated with the users that provided the answers as input into a mathematical model that outputs a probability value that indicating an estimated likelihood that the test question will be answered correctly. The difficulty score determination component 212 then uses the probability value to determine the difficulty score for the test questions. Using the user profile data for the users to determine difficulty scores allows for the experience level or other features of the users to be considered when determining the difficulty of a test question. For example, a test question that was answered correctly by experienced users may still be factored as being a difficult test question.

The mathematical model may be any type of suitable mathematical model that can be trained to output a probability value based on a given input. For example, the mathematical model may be a psychometric model such as a Rasch model, a Linear Regression model, Logistic Regression model, and the like. The mathematical model is trained based on historical test data describing previous test questions administered to users of the employment services platform 106, including answers provided by users of the employment services platform 106 to the previously administered test questions (e.g., whether the test questions were answered correctly or incorrectly) and user profile data for the users of the employment services platform 106 that provided the answers. The user profile data and answers are used to train the mathematical model.

In some embodiments, the user profile data may be used to generate an embedding vector representing the user. For example, the embedding vector may include values representing the user according to a set of selected features. The set of features represent aspects of a user considered to be relevant for determining the difficultly of a test question, such as by indicating an experience level of the user. For example, the set of features may include features representing a number of years of experience of the user, an extent of education of the user, job titles of the user, identified skills, and the like. To generate the embedding vector for a user, the user's profile data is analyzed to determine values for each feature. For example, the user's profile data can be analyzed to determine the number of years of experience that the user has, which is then used to determine the value in the embedding vector to represent this feature. The resulting embedding vector is a collection of values that represents each feature of the user.

The trained mathematical model outputs a probability value indicating a likelihood that a test question will be answered correctly given a specified input. For example, the trained mathematical model may receive answers to test questions and embedding vectors representing the users that provided the answers as input and output the probability value. The difficulty score determination component 212 may determine the difficulty score for a test question by generating embedding vectors based on the user profiles of the user that provided the set of answers and using the embedding vectors and the set of answers as input into the trained mathematical model.
The difficulty score determination component 212 may determine the difficulty score based on the probability value in any of a variety of ways. As explained earlier, the probability value indicates a likelihood that the test question will be answered correctly. In some embodiments, the difficulty score may simply be the same at the probability value. Alternatively, the difficulty score determination component 212 may determine the difficulty value by applying a mathematical function based on the probability value. For example, the mathematical function may be multiplying the probability value by 100, or the like. The difficulty score determination component 212 may store the difficulty values determined for the test questions in the assessment test storage 222.

The test calibration component 214 uses the difficulty scores determined for the test questions to calibrate a skill assessment test. This may include generating a new skill assessment test or recalibrating an existing skill assessment test. For example, the test calibration component 214 selects a set of test questions to include in the skill assessment test to maintain a pass rate that is below a desired threshold pass rate. This can ensure that only users with at least a certain level of proficiency in the skill are able to successfully pass the skill assessment test. The test calibration component 214 uses the difficulty scores assigned to test questions to select test question for the skill assessment test. As explained earlier, the difficulty scores are based on a probability that the test question will be answered correctly. The test calibration component 214 may use these determined probabilities to formulate a skill assessment test with test questions that provide overall likelihood of being passed that is at or below the desired threshold pass rate. The test calibration component 214 may store new skill assessment tests in the assessment test storage 222, as well as modify data related to existing skill assessment tests, such as when a skill assessment test is recalibrated.

The test monitoring component 216 monitors performance of live skill assessment test that are administered to users to ensure that the skill assessment test is properly calibrated and performing as desired. For example, the test monitoring component 216 may periodically determine an overall pass rate of the skill assessment test and determine whether the pass rate exceeds the desired threshold pass rate for the skill assessment test. In the event that the pass rate for a skill assessment test does exceed the desired threshold pass rate, the test monitoring component 216 may pause administration of the skill assessment test during which the skill assessment test is not administered to users. For example, the test monitoring component 216 may update the assessment test storage 222 to indicate that the skill assessment test should not be administered.

During the pause, the skill assessment test can be recalibrated. For example, the test monitoring component 216 may communicate with the other component of the assessment test calibration system 108 to cause the skill assessment test to be recalibrated and/or cause difficulty scores for the included test questions to be updated. After the skill assessment test has been recalibrated, the assessment test storage 222 can be updated to indicate that the skill assessment test can be administered to users as a live skill assessment test.

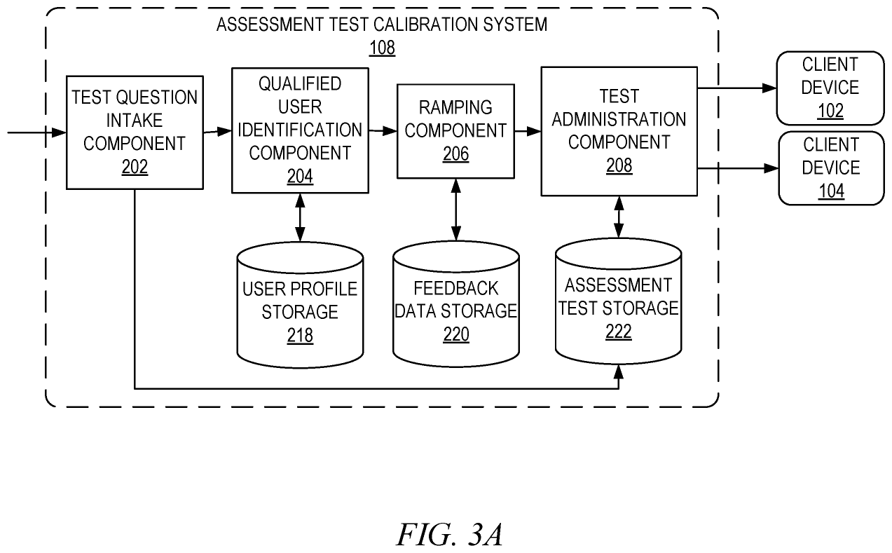

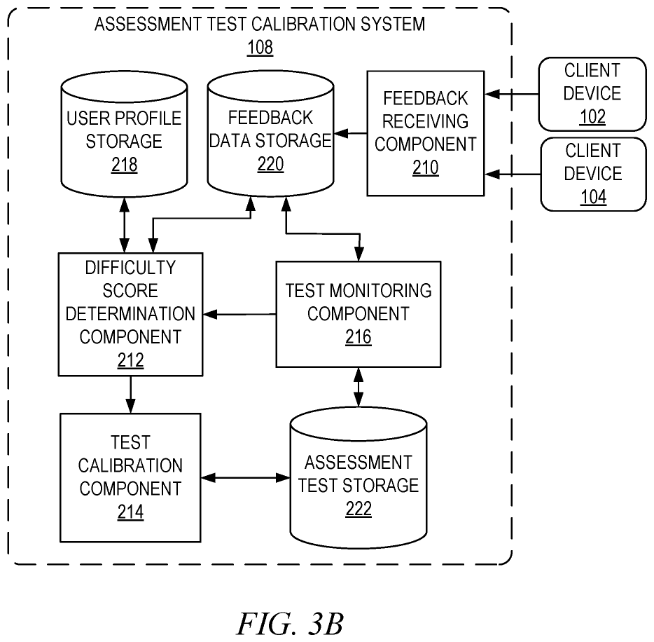

FIGS. 3A and 3B are block diagrams illustrating the functionality of the assessment test calibration system 108, according to some example embodiments. To avoid obscuring the inventive subject matter with unnecessary detail, various functional components (e.g., software components) that are not germane to conveying an understanding of the inventive subject matter have been omitted from FIGS. 3A and 3B. However, a skilled artisan will readily recognize that various additional functional components may be supported by the assessment test calibration system 108 to facilitate additional functionality that is not specifically described herein. Furthermore, the various functional components depicted in FIGS. 3A and 3B may reside on a single computing device or may be distributed across several computing devices in various arrangements such as those used in cloud-based architectures.

FIG. 3A illustrates the assessment test calibration system 108 providing test questions to users for purposes of gathering feedback data. As shown, the test question intake component 202 intakes test questions. The test question may be new test question for which a difficulty score has not yet been determined. For example, a test question may be received from a content creator and/or from a content management system. The test question may include data identifying a skill and/or skill assessment test associated with the test question. The test question intake component 202 may store the received test question and associated data in the assessment test storage 222.

The test question intake component 202 may also communicate with the qualified user identification component 204 to cause the qualified user identification component 204 to identify a set of users for the test question. The qualified user identification component 204 may use profile data of the users of the employment services platform 106 to identify users that possess a specified skill profile that qualify the users as being able to answer the test question. The qualified user identification component 204 identifies the qualified users by accessing user profile data from the user profile storage 218. The qualified user identification component 204 searches the profile data based on the specified skill profile for a test question to identify a subset of the qualified users of the employment services platform 106 to which the test question can be administered for purposes of determining difficulty scores.

The ramping component 206 may determine a number of the qualified users to receive the test question, as well as select the user. The ramping component 206 selects the number of qualified users based on a target number of responses and a historical response rate that indicates the percentage of users that will provide a response within a specified time period when prompted to answer the question. The target number of responses is a number of responses that is determined to be needed to determine the difficulty score for a test question. The ramping component 206 uses the historical response rate to determine the number of users to which the test question should be presented to cause the target number of responses (e.g., answers) to be received so that the difficulty score can be successfully determined within the target time frame.

The ramping component 206 may select the number of users to minimize the number of responses received in excess of the target number of responses. For example, the ramping component 206 may select a number of users to result in exactly the number of target response or within a threshold amount, either above or below, the target number of responses. The ramping component 206 may communicate with the feedback data storage 220 to monitor the number of responses received to a test question and determine that the number of additional users to which the test question should be presented should be increased or decreased. For example, the ramping component 206 may select a number of users to receive the test question during an initial phase and determine the number of users to receive the test question during a subsequent phase based on the number of responses received during the initial phase. The ramping component 206 may select the users to receive the test question at random from the set of qualified users identified by the qualified user identification component 204.

The ramping component 206 communicates with the test administration component 208 to cause the test question to be presented to the selected users. For example, the ramping component 206 may provide the test administration component 208 with data identify the selected users to receive the test question. The test administration component 208 accesses the test question from the assessment test storage 222, which may be administered within a live skill assessment test or a beta skill assessment test. Administering a skill assessment test causes the test questions to be administered to a user via a test interface presented on a display of a client device 102, 104.

FIG. 3B illustrates the assessment test calibration system 108 calibrating skill assessment tests based on received feedback data. As shown, the feedback receiving component 210 receives feedback data from the client devices 102, 104. The feedback data includes data indicating answers provided by users to test questions. The feedback receiving component 210 updates the feedback data storage 220 based on the received feedback data.

The difficulty score determination component 212 determines the difficulty score for a test question based on the feedback data stored in the feedback data storage 220 and the user profile data stored in the user profile data storage 218. For example, the difficulty score determination component 212 uses the answers provided by the users to the test question along with user profile data associated with the users that provided the answers as input into a model that outputs a probability value that indicating an estimated likelihood that the test question will be answered correctly. The difficulty score determination component 212 then uses the probability value to determine the difficulty score for the test questions. The mathematical model may be any type of suitable model that can be trained to output a probability value based on a given input, such as a Rasch model, a Linear Regression model, Logistic Regression model, and the like.

In some embodiments, the user profile data may be used to generate embedding vectors representing each user. For example, the embedding vector may include values for a set of features based on the user profile data for each user. The embedding vectors generated for the users may be used to train the mathematical model as well as used as input when determining a difficulty score for a test question.

The difficulty score determination component 212 may determine the difficulty score based on the probability value in any of a variety of ways. As explained earlier, the probability value indicates a likelihood that the test question will be answered correctly. In some embodiments, the difficulty score may simply be the same at the probability value. Alternatively, the difficulty score determination component 212 may determine the difficulty value by applying a mathematical function based on the probability value. For example, the mathematical function may be multiplying the probability value by 100, of the like. The difficulty score determination component 212 may store the difficulty values determined for the test questions in the assessment test storage 222.

The test calibration component 214 uses the difficulty scores determined for the test questions to calibrate the skill assessment tests. This may include selecting a set of test questions of adequate difficulty levels to maintain a pass rate that is below a desired threshold pass rate. This can ensure that only users with at least a certain level of proficiency in the skill are able to successfully pass the skill assessment test. The test calibration component 214 may store new skill assessment tests in the assessment test storage 222, as well as modify data related to existing skill assessment tests, such as when a skill assessment test is recalibrated.

The test monitoring component 216 monitors performance of live skill assessment test that are administered to users to ensure that the skill assessment test is properly calibrated and performing as desired. For example, the test monitoring component 216 may periodically determine an overall pass rate of the skill assessment test and determine whether the pass rate does not exceed the desired threshold pass rate for the skill assessment test. In the event that the pass rate for a skill assessment test does exceed the desired threshold pass rate, the test monitoring component 216 may pause administration of the skill assessment test during which the skill assessment test is not administered to users. For example, the test monitoring component 216 may update the assessment test storage 222 to indicate that the skill assessment test should not be administered.

During the pause, the skill assessment test can be recalibrated. For example, the test monitoring component 216 may communicate with the other component of the assessment test calibration system 108 to cause the skill assessment test to be recalibrated and/or cause difficulty scores for the included test questions to be updated. After the skill assessment test has been recalibrated, the assessment test storage 222 can be updated to indicate that the skill assessment test can be administered to users as a live skill assessment test.

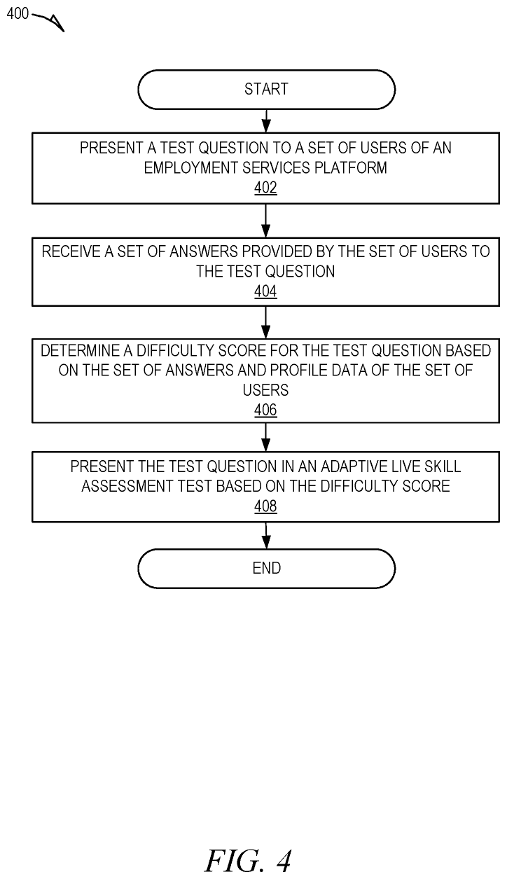

FIG. 4 is a flowchart showing an example method 400 of skill assessment test calibration, according to certain example embodiments. The method 400 may be embodied in computer readable instructions for execution by one or more processors such that the operations of the method 400 may be performed in part or in whole by the assessment test calibration system 108; accordingly, the method 400 is described below by way of example with reference thereto. However, it shall be appreciated that at least some of the operations of the method 400 may be deployed on various other hardware configurations and the method 400 is not intended to be limited to the assessment test calibration system 108.

At operation 402, the test question administration component 208 presents a test question to a set of users of an employment services platform. The test question administration component 208 may present the test question as part of a live skill assessment test or a beta skill assessment test. A beta skill assessment test may be an assessment test that includes multiple test questions that have not yet been calibrated and which is administered to users with the primary goal of determining the difficulty values for the test questions rather than determining whether a user is adequately proficient at a certain skill.

In contrast, a live skill assessment test is an assessment test that has been calibrated and that is administered with the primary goal of determining whether a user is adequately proficient at a certain skill. A test question that has not yet been assigned a difficulty score may be included as a test question in the live skill assessment test along with other test questions that have been assigned difficulty scores. The test question may be presented in the live skill assessment test for experimental purposes to gather feedback data used for determining the difficulty value of the test question and therefore may have no impact on whether a user passes or fails the live skill assessment test.

The test question administration component 208 may present the test question to a subset of qualified users identified by the qualified user identification component 204. Further, the users selected to receive the test question may be selected by ramping component 206 to meet a target number of responses within a target time frame, which also minimizing the number of responses received above the target number.

At operation 404, the feedback receiving component receives a set of answers provided by the set of users to the test question. The answers may be stores and associated with data identifying the user that provided the answers.

At operation 406, the difficulty score determination component 212 determines a difficulty score for the test question based on the set of answers and the profile data of the set of users. For example, the difficulty score determination component 212 uses the answers provided by the users along with the user profile data as input into a model that outputs a probability value that indicates an estimated likelihood that the test question will be answered correctly. The difficulty score determination component 212 then uses the probability value to determine the difficulty score for the test questions. The mathematical model may be any type of suitable model that can be trained to output a probability value based on a given input, such as a Rasch model.

At operation 408, the test question administration component 208 presents the test question in an adaptive live skill assessment test based on the difficulty score. An adaptive skill assessment test is a test in which the test questions presented to the test taker are selected based on the performance of the test taker. For example, a test taker that has answered a test question or set of test questions correctly may be presented with a subsequent test question that is more difficult than the previously presented test questions. Similarly, a test taker that has answered a test question or set of test questions incorrectly may be presented with a subsequent test question that is less difficult than the previously presented test questions. To administer an adaptive skill assessment test, the test administration component 208 uses the difficulty scores assigned to the test questions to select the subsequent test question to be presented to the user.

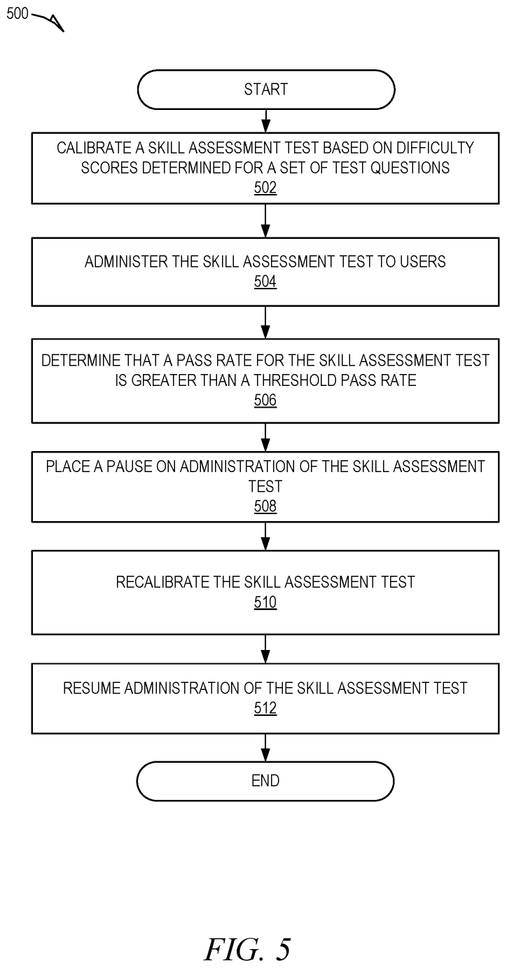

FIG. 5 is a flowchart showing an example method 500 of recalibrating a skill assessment test, according to certain example embodiments. The method 500 may be embodied in computer readable instructions for execution by one or more processors such that the operations of the method 500 may be performed in part or in whole by the assessment test calibration system 108; accordingly, the method 500 is described below by way of example with reference thereto. However, it shall be appreciated that at least some of the operations of the method 500 may be deployed on various other hardware configurations and the method 500 is not intended to be limited to the assessment test calibration system 108.

At operation 502, the assessment test calibration component 214 calibrates a skill assessment test based on difficulty scores determined for a set of test questions. For example, the assessment test calibration component 214 selects a set of test questions of adequate difficulty levels to maintain a pass rate that is at or below a desired threshold pass rate. This can ensure that only users with at least a certain level of proficiency in the skill are able to successfully pass the skill assessment test.

At operation 504, the test question administration component 208 administers the skill assessment test to users. For example, the test administration component 208 causes presentation of a test interface on a client device 102 of a user. The test interface presents test questions to users and allows users to provide answers to the presented questions, such as by entering an answer and/or selecting from a presented possible answer.

At operation 506, the live assessment test monitoring component 216 determines that a pass rate for the skill assessment test is greater than a threshold pass rate. The test monitoring component 216 may periodically determine an overall pass rate of the skill assessment test and determine whether the pass rate exceed the desired threshold pass rate for the skill assessment test.

At operation 508, the live assessment test monitoring component 216 places a pause on administration of the skill assessment test. For example, the test monitoring component 216 may update the assessment test storage 222 to indicate that the skill assessment test should not be administered

At operation 510, the assessment test calibration component 214 recalibrates the skill assessment test. For example, the assessment test calibration component 214 may recalibrate the skill assessment test based on updated difficulty scores for the test questions included in the skill assessment test. The assessment test calibration component 214 may also recalibrate the skill assessment test or include test questions with higher difficulty scores with the goal of reducing the pass rate.

At operation 512, the test question administration component 208 resumes administration of the skill assessment test. Administration of the skill assessment test is based on the recalibration, such as being based on the updates difficulty scores.

### Software Architecture

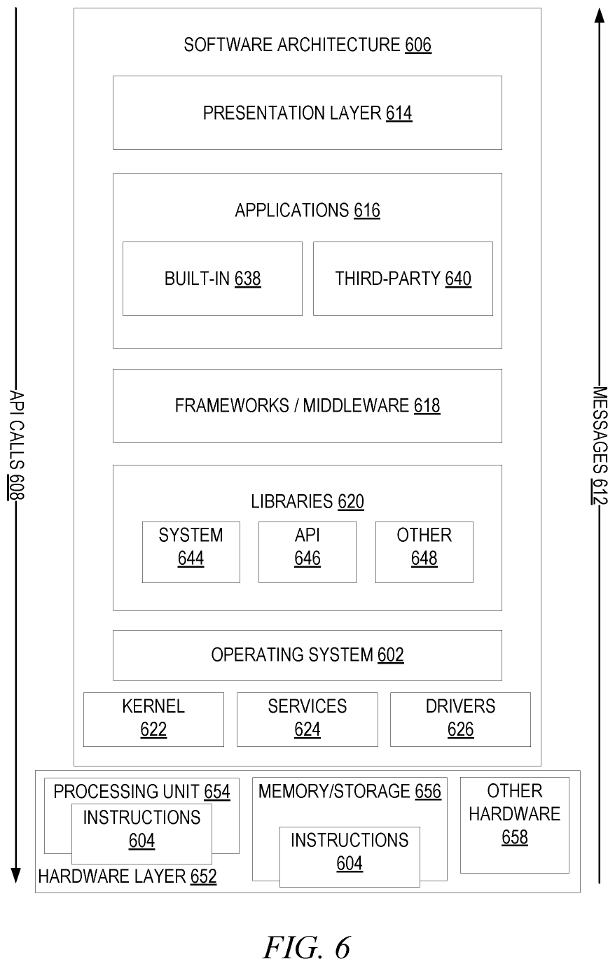

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage components 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components.

The frameworks/middleware 618 (also sometimes referred to as middleware) provide a higher-level common infrastructure that may be used by the applications 616 and/or other software components. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor 704) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 704 may further be a multi-core processor having two or more independent processors 704 (sometimes referred to as “cores”) that may execute instructions 710 contemporaneously.

What is claimed is:

1. A method comprising:
presenting a first test question to a first set of users of an employment services platform, the first test question being related to a first skill, the first set of users having been selected based on profile data included in user profiles of the first set of users and the first skill;
receiving a set of answers provided by the first set of users for the first test question;
determining a difficulty score for the first test question, the difficulty score indicating an estimated level of difficulty of the first test question, the difficulty score being determined by using the set of answers provided by the first set of users and the profile data included in the user profiles of the first set of users as input into a mathematical model that outputs a respective probability value based on a respective input test question, the respective probability value indicating a likelihood that the respective input test question will be answered correctly, the mathematical model having been trained based on historical test data describing previous test questions administered to users of the employment services platform, answers received for the previous test questions, and profile data of the users that answered the previous test questions; and
calibrating a skill assessment test based on the difficulty score for the first test questions, yielding the skill assessment test including the first test question.

2. The method of claim 1, further comprising:
identifying a set of candidate users of the employment services platform that have the first skill listed as a possessed skill in their user profiles; and
selecting the first set of users from the set if candidate users of the employment services platform, wherein at least one candidate user from the set of candidate users is not selected for inclusion in the first set of users.

3. The method of claim 2, wherein selecting the first set of users from the first subset of users comprises:
determining, based on a historical response rate, a number of users to receive the first test question to achieve a target number of responses within a target time frame; and
selecting the first set of users based on the number of users to receive the first test question to achieve the target number of responses within the target time frame.

4. The method of claim 1, wherein the first test question is presented to the first set of users within a live skill assessment test that includes at least a second test question that has an assigned difficulty score.

5. The method of claim 1, wherein the first test question is presented to the first set of users within a beta skill assessment test including a set of other test questions that have been assigned difficulty scores.

6. The method of claim 5, further comprising:
determining difficulty scores for the set of other test questions based on sets of answers provided by the first set of users for the set of other test questions, wherein the skill assessment test is calibrated based on the first difficulty score and the difficulty scores for the set of other test questions.

7. The method of claim 6, further comprising:
administering the skill assessment test to users of the employment services;
determining a pass rate for the skill assessment test;
comparing the pass rate to a threshold pass rate;
in response to determining that the pass rate is higher than the threshold pass rate:
pausing administration of the skill assessment test to users of the employment services platform; and
recalibrating the skill assessment test based on updated difficulty scores for the first test question and the set of other test questions, yielding a recalibrated skill assessment test; and
resuming administration of the recalibrated skill assessment test to users of the employment services platform.

8. The method of claim 1, wherein determining the difficulty score for the first test question comprises:
generating a set of embedding vectors based on the user profile data included in the first set of user profiles;
determining a first probability value indicating a likelihood that the first test question will be answered correctly by using the set of embedding vectors and the set of answers provided by the first set of users as input into the mathematical model; and
determining the difficulty score for the first test question based on the first probability value.

9. The method of claim 8, further comprising:
generating, based on the profile data of the users that answered the previous test questions included in the historical test data, a set of training embedding vectors; and
training the mathematical model based on the set of training embedding vectors and the answers received for the previous test questions.

10. A system comprising:
one or more computer processors; and
one or more computer-readable mediums storing instructions that, when executed by the one or more computer processors, cause the system to perform operations comprising:
presenting a first test question to a first set of users of an employment services platform, the first test question being related to a first skill, the first set of users having been selected based on profile data included in user profiles of the first set of users and the first skill;
receiving a set of answers provided by the first set of users for the first test question;
determining a difficulty score for the first test question, the difficulty score indicating an estimated level of difficulty of the first test question, the difficulty score being determined by using the set of answers provided by the first set of users and the profile data included in the user profiles of the first set of users as input into a mathematical model that outputs a respective probability value based on a respective input test question, the respective probability value indicating a likelihood that the respective input test question will be answered correctly, the mathematical model having been trained based on historical test data describing previous test questions administered to users of the employment services platform, answers received for the previous test questions, and profile data of the users that answered the previous test questions; and
calibrating a skill assessment test based on the difficulty score for the first test questions, yielding the skill assessment test including the first test question.

11. The system of claim 10, the operations further comprising:
identifying a set of candidate users of the employment services platform that have the first skill listed as a possessed skill in their user profiles; and
selecting the first set of users from the set if candidate users of the employment services platform, wherein at least one candidate user from the set of candidate users is not selected for inclusion in the first set of users.

12. The system of claim 11, wherein selecting the first set of users from the first subset of users comprises:
determining, based on a historical response rate, a number of users to receive the first test question to achieve a target number of responses within a target time frame; and
selecting the first set of users based on the number of users to receive the first test question to achieve the target number of responses within the target time frame.

13. The system of claim 10, wherein the first test question is presented to the first set of users within a live skill assessment test that includes at least a second test question that has an assigned difficulty score.

14. The system of claim 10, wherein the first test question is presented to the first set of users within a beta skill assessment test including a set of other test questions that have been assigned difficulty scores.

15. The system of claim 14, the operations further comprising:
determining difficulty scores for the set of other test questions based on sets of answers provided by the first set of users for the set of other test questions, wherein the skill assessment test is calibrated based on the first difficulty score and the difficulty scores for the set of other test questions.

16. The system of claim 15, the operations further comprising:
administering the skill assessment test to users of the employment services;
determining a pass rate for the skill assessment test;
comparing the pass rate to a threshold pass rate;
in response to determining that the pass rate is higher than the threshold pass rate:
pausing administration of the skill assessment test to users of the employment services platform; and
recalibrating the skill assessment test based on updated difficulty scores for the first test question and the set of other test questions, yielding a recalibrated skill assessment test; and
resuming administration of the recalibrated skill assessment test to users of the employment services platform.

17. The system of claim 10, wherein determining the difficulty score for the first test question comprises:
generating a set of embedding vectors based on the user profile data included in the first set of user profiles;
determining a first probability value indicating a likelihood that the first test question will be answered correctly by using the set of embedding vectors and the set of answers provided by the first set of users as input into the mathematical model; and
determining the difficulty score for the first test question based on the first probability value.

18. The system of claim 17, the operations further comprising:
generating, based on the profile data of the users that answered the previous test questions included in the historical test data, a set of training embedding vectors; and
training the mathematical model based on the set of training embedding vectors and the answers received for the previous test questions.

19. A non-transitory computer-readable medium storing instructions that, when executed by one or more computer processors of one or more computing devices, cause the one or more computing devices to perform operations comprising:
presenting a first test question to a first set of users of an employment services platform, the first test question being related to a first skill, the first set of users having been selected based on profile data included in user profiles of the first set of users and the first skill;
receiving a set of answers provided by the first set of users for the first test question;
determining a difficulty score for the first test question, the difficulty score indicating an estimated level of difficulty of the first test question, the difficulty score being determined by using the set of answers provided by the first set of users and the profile data included in the user profiles of the first set of users as input into a mathematical model that outputs a respective probability value based on a respective input test question, the respective probability value indicating a likelihood that the respective input test question will be answered correctly, the mathematical model having been trained based on historical test data describing previous test questions administered to users of the employment services platform, answers received for the previous test questions, and profile data of the users that answered the previous test questions; and
calibrating a skill assessment test based on the difficulty score for the first test questions, yielding the skill assessment test including the first test question.

20. The non-transitory computer-readable medium of claim 19, the operations further comprising:
identifying a set of candidate users of the employment services platform that have the first skill listed as a possessed skill in their user profiles; and
selecting the first set of users from the set if candidate users of the employment services platform, wherein at least one candidate user from the set of candidate users is not selected for inclusion in the first set of users.
